(19) United States
(12) Patent Application Publication
(10) Pub. No.: US 2018/0238079 A1
(43) Pub. Date: Aug. 23, 2018

(54) Security Key Hasp

(71) Applicants: Ronald Douglas Burnette, Rockmart, GA (US); Marc Murchison, Carrollton, GA (US)

(72) Inventors: Ronald Douglas Burnette, Rockmart, GA (US); Marc Murchison, Carrollton, GA (US)

(21) Appl. No.: 15/899,239

(22) Filed: Feb. 19, 2018

Related U.S. Application Data
(60) Provisional application No. 62/461,338, filed on Feb. 21, 2017.

(51) Int. Cl. E05B 19/00; E05B 65/48

(52) U.S. Cl. CPC E05B 19/0005; E05B 67/32; E05B 65/48

(57) ABSTRACT

A security device for securing a key by using multiple locks consists of a first rotational member, a second rotational member, a pivoting mechanism, a first plurality of lock-receiving holes, and a second plurality of lock-receiving holes. The key that needs to be secured is enclosed by the first rotational member and the second rotational member that are connected to each other through the pivoting mechanism. The pivoting mechanism allows the key to be either exposed or concealed upon user preference. The first plurality of lock-receiving holes and the second plurality of lock-receiving holes are designed and positioned to receive a shackle from at least one lock so that the key is securely enclosed by the first rotational member and the second rotational member.

The current application claims a priority to the U.S. Provisional Patent application Ser. No. 62/461,338 filed on Feb. 21, 2017.

### FIELD OF THE INVENTION

The present invention relates generally to a security apparatus that retains a key or other comparable verification item. The present invention is designed so that multiple stages of unlocking is required before accessing the stored key or stored verification item.

### BACKGROUND OF THE INVENTION

Security articles of today require a substantially bulky and large frame where there is a need for redundancy in the locking mechanism as facilitated among a plurality of users where a single key or other planar verification article must be secured. The present invention would seek to improve upon this securing standard through the use of a relatively flat pair of rotational planar members that allows a pivoting mechanism to operate between the two, where the article may be housed in an interstitial cavity created by the first, second, or both planar members. The apparatus would further provide for the user to secure the hasp apparatus to a stationary article that prevents the apparatus from being moved from a work environment or readily affixed to a structure the key within corresponds to. As current key storage security apparatuses present a large volume cavity compared to the present apparatus, the present apparatus allows for the expansion of storage space by permitting additional pairs of first and second planar members to be secured to the first pair through either a first or second member pair-adjoining fastener, allowing the additional pairs of rotational planar members to be stacked.

By utilizing the present invention, the space consumption is reduced, and convenience is maximized. Moreover, the effective design of the present invention allows multiple units to be linked together for added convenience.

### BRIEF DESCRIPTION OF THE DRAWINGS

FIG. 1 is a perspective view of the present invention, wherein the present invention is in a locked configuration.

FIG. 2 is a perspective view of the present invention, wherein the present invention is in an unlocked configuration.

FIG. 3 is a front view of the present invention in the locked configuration.

FIG. 4 is a front view of the present invention in the unlocked configuration.

FIG. 5 is a perspective exploded view of the present invention.

FIG. 6 is a perspective view of the present invention, wherein at least one lock is placed into a first plurality of lock-receiving holes and a second plurality of lock-receiving holes.

### DETAIL DESCRIPTIONS OF THE INVENTION

All illustrations of the drawings are for the purpose of describing selected versions of the present invention and are not intended to limit the scope of the present invention.

The present invention introduces a security device for retaining a key. The effective design of the present invention allows the key to be secured in a key-receiving slot secured by multiple locks. The size and shape of the body surrounding the key-receiving slot minimizes the overall space consumption of the security apparatus while fulfilling the intended functionality.

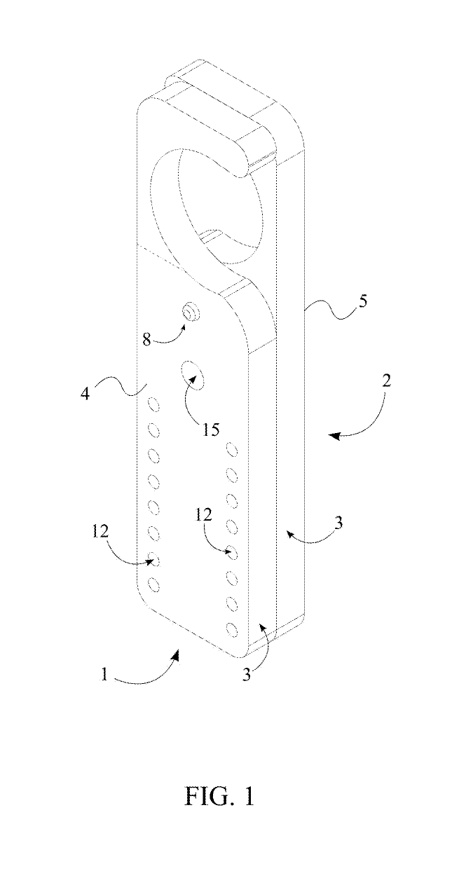

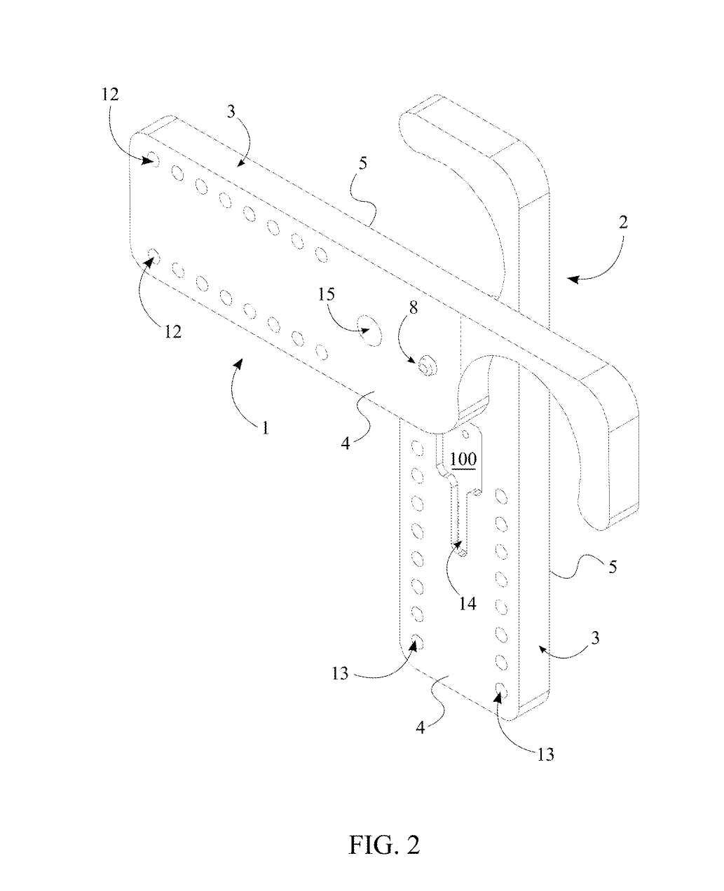

As seen in FIG. 1 and FIG. 2, to achieve the intended functionalities, the present invention comprises a first rotational member 1, a second rotational member 2, a pivoting mechanism 8, a first plurality of lock-receiving holes 12, and a second plurality of lock-receiving holes 13. The first rotational member 1 and the second rotational member 2 are used to enclose a key 100 that needs to be retained. The pivoting mechanism 8 is used to control the position of the first rotational member 1 and the second rotational member 2 when storing and accessing the key 100. More specifically, the first rotational member 1 is pivotally connected to the second rotational member 2 through the pivoting mechanism 8. The pivoting mechanism can vary in different embodiments of the present invention. The first plurality of lock-receiving holes 12 and the second plurality of lock-receiving holes 13 work in conjunction to secure the key 100. More specifically, a plurality of shackles from a set of locks is positioned into the first plurality of lock-receiving holes 12 and the second plurality of lock-receiving holes 13.

As mentioned before, the key 100 used with the present invention is enclosed by the first rotational member 1 and the second rotational member 2. To do so, the first rotational member 1 and the second rotational member 2 each comprise a structural body 3. The size and shape of the structural body 3 and the materials that are used to manufacture the structural body 3 can vary in different embodiments of the present invention. To receive and position the set of locks that secure the key 100, the first plurality of lock-receiving holes 12 traverses through the structural body 3 of the first rotational member 1. Similarly, the second plurality of lock-receiving holes 13 traverses through the structural body 3 of the second rotational member 2.

When the key 100 is secured with the first rotational member 1 and the second rotational member 2, the present invention is in a locked configuration as in FIG. 1. In the locked configuration, the first plurality of lock-receiving holes 12 is concentrically aligned with the second plurality of lock-receiving holes 13 in order to receive a shackle of each of the set of locks. When the key 100 needs to be accessed, the present invention obtains an unlocked configuration as in FIG. 2. In the unlocked configuration, the first plurality of lock-receiving holes 12 is offset from the second plurality of lock-receiving holes 13. To offset the first plurality of lock-receiving holes 12 from the second plurality of lock-receiving holes 13, the first rotational member 1 is swiveled away from the second rotational member 2 via the pivoting mechanism 8 after the set of locks is removed.

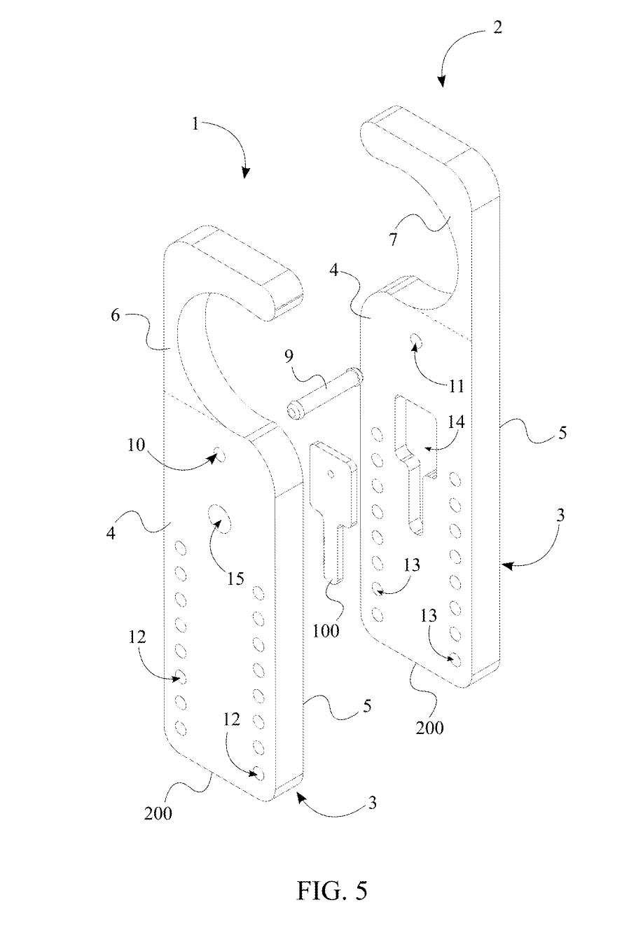

As shown in FIG. 5, the first rotational member 1 and the second rotational member 2 each further comprise a top surface 4 and a bottom surface 5. The distance between the top surface 4 and the bottom surface 5 determines an overall thickness of the structural body 3. Thus, when the first plurality of lock-receiving holes 12 traverse through the structural body 3 of the first rotational member 1, the first plurality of lock-receiving holes 12 extends from the top surface 4 to the bottom surface 5 of the first rotational member 1. Likewise, when the second plurality of lock-receiving holes 13 traverse through the structural body 3 of the second rotational member 2, the second plurality of lock-receiving holes 13 extends from the top surface 4 to the bottom surface 5 of the second rotational member 2.

As further illustrated in FIG. 2 and FIG. 5, to retain the key 100 with the first rotational member 1 and the second rotational member 2, the present invention further comprises a key-receiving slot 14 that traverses into the structural body 3 at the top surface 4 of the second rotational member 2. To not hinder the process of receiving the set of locks, the key-receiving slot 14 is positioned adjacent the second plurality of lock-receiving holes 13. The size of the key-receiving slot 14 can vary in different embodiments to accommodate different sized keys. In another embodiment of the present invention, the structural body 3 can be designed to have a larger surface area so that multiple key-receiving slots can be integrated into the structural body 3.

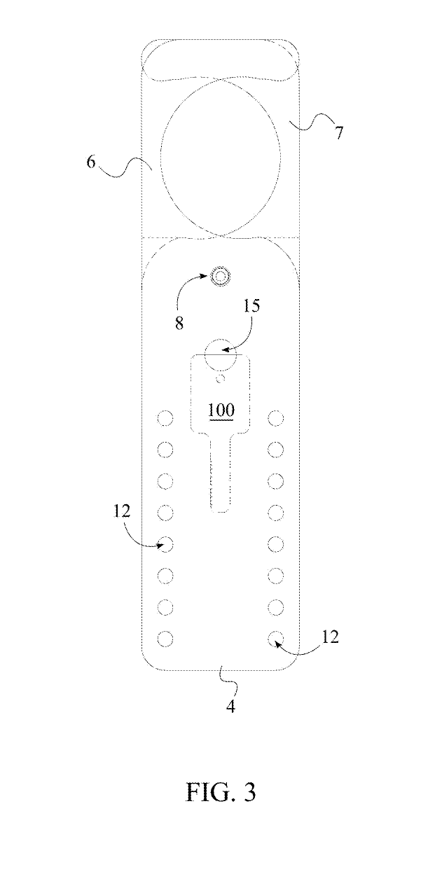

As seen in FIG. 3, the present invention further comprises a viewing aperture 15 to notify the user regarding the presence of the key 100. The viewing aperture 15 traverses through the structural body 3 of the first rotational member 1. Therefore, the key 100 positioned adjacent the top surface 4 of the second rotational member 2 can be viewed through the viewing aperture 15. More specifically, the viewing aperture 15 is aligned with the key-receiving slot 14 in the locked configuration and is positioned adjacent the first plurality of lock-receiving holes 12. Therefore, the key 100 can be viewed in the locked configuration. In some embodiments of the present invention, the viewing aperture 15 and key-receiving slot 14 are each positioned laterally central on the first rotational member 1 and the second rotational member 2 respectively.

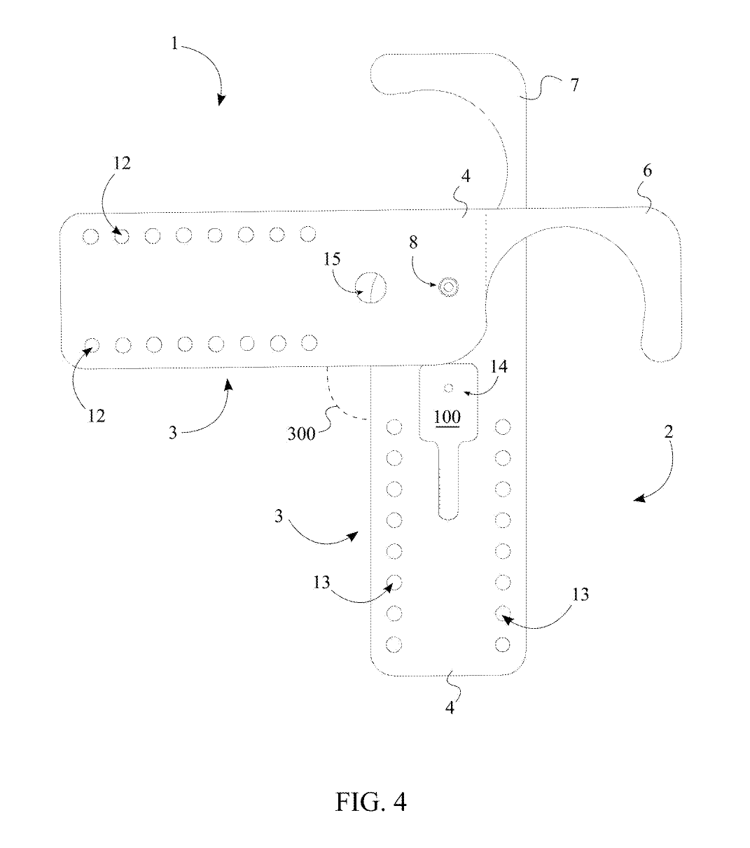

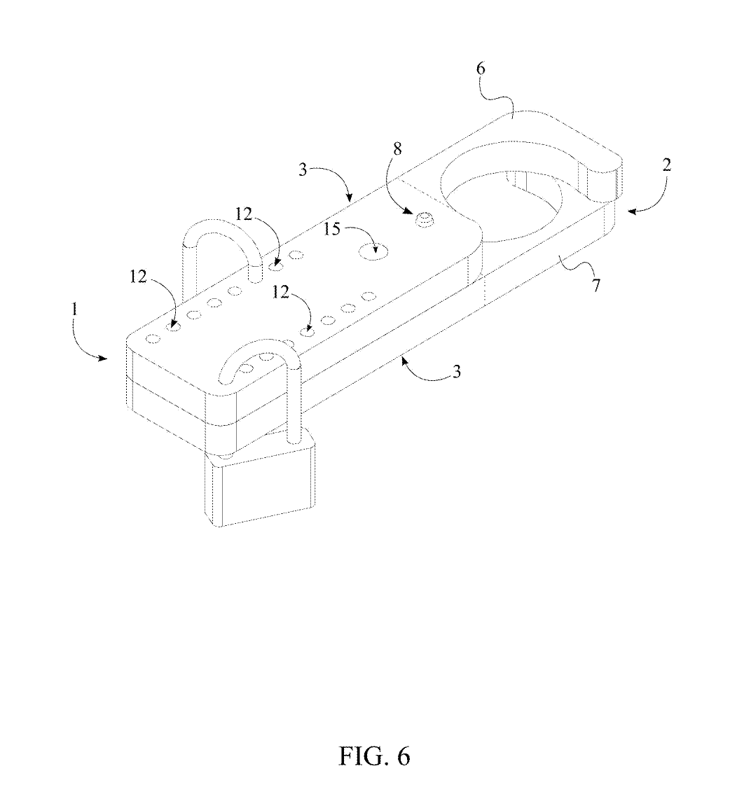

As discussed before, the present invention retains the key 100 in the locked configuration and provides access to the key 100 in the unlocked configuration. In the locked configuration, the first rotational member 1 is positioned in parallel to the second rotational member 2 as seen in FIG. 1 and FIG. 6. On the other hand, in the unlocked configuration, the first rotational member 1 is oriented at an angle 300 to the second rotational member 2 as seen in FIG. 2 and FIG. 4.

The present invention interchanges between the locked configuration and the unlocked configuration via the pivoting mechanism 8. As illustrated in FIG. 5, in the preferred embodiment of the present invention, the pivoting mechanism 8 comprises a rivet 9, a first rivet-receiving hole 10, and a second rivet-receiving hole 11. The first rivet-receiving hole 10 traverses through the structural body 3 of the first rotational member 1. Similarly, the second rivet-receiving hole 11 traverses through the structural body 3 of the second rotational member 2. To swivel the first rotational member 1 about the second rotational member 2, the first rivet-receiving hole 10 is concentrically aligned with the second rivet-receiving hole 11, and the rivet 9 is positioned into both the first rivet-receiving hole 10 and the second rivet-receiving hole 11.

As further illustrated in FIG. 5, the present invention further comprises a first arced portion 6 and a second arced portion 7 that allows the present invention to be mounted onto a surface. More specifically, the first arced portion 6 and the second arced portion 7 allow the present invention to be secured against a surface so that unauthorized transportation of the key 100 is prevented. To do so, the first arced portion 6 is terminally connected to the structural body 3 of the first rotational member 1. More specifically, the first arced portion 6 is positioned adjacent the first-rivet receiving hole 10 and opposite a bottom edge 200 of the first rotational member 1. On the other hand, the second arced portion 7 is terminally connected to the structural body 3 of the second rotational member 2. More specifically, the second arced portion 7 is positioned adjacent the second rivet-receiving hole 11 and opposite a bottom edge 200 of the second rotational member 2.

When the present invention is in the locked configuration, the first arced portion 6 is oriented inverse to the second arced portion 7. Moreover, the first arced portion 6 is positioned above the second arced portion 7. Thus, a hook or similar means can be inserted through the opening delineated by the first arced portion 6 and the second arced portion 7. The first arced portion 6 and the second arced portion 7 can also be designed to attach multiple units of the present invention. More specifically, the first arced portion 6 and the second arced portion 7 can be designed to be positioned into the first plurality of lock-receiving holes 12 and the second plurality of lock-receiving holes 13 of an arbitrary first rotational member and an arbitrary second rotational member.

When considering an overview of the first rotational member 1, the viewing aperture 15 is positioned between the first rivet-receiving hole 10 and the first plurality of lock-receiving holes 12. Moreover, the first rivet-receiving hole 10 is positioned in between the first arced portion 6 and the viewing aperture 15. When considering an overview of the second rotational member 2, the key-receiving slot 14 is positioned in between the second rivet-receiving hole 11 and the second plurality of lock-receiving holes 13. Moreover, the second rivet-receiving hole 11 is positioned in between the second arced portion 7 and the key-receiving slot 14.

When the present invention is in use, the following process flow is generally followed. Initially, the first rotational member 1 is swiveled away from the second rotational member 2 via the pivoting mechanism 8 so that the key-receiving slot 14 is exposed. Thus, the present invention is in the unlocked configuration. When the key-receiving slot 14 is exposed, the key 100 is removably positioned into the key-receiving slot 14 and the first rotational member 1 is swiveled back to be positioned atop the second rotational member 2 via the pivoting mechanism 8. More specifically, the first rotational member 1 is positioned atop the second rotational member 2 so that the first plurality of lock-receiving holes 12 is concentrically aligned with the second plurality of lock-receiving holes 13. Simultaneously, the key-receiving slot 14 is concealed. When the first rotational member 1 and the second rotational member 2 are positioned appropriately, a shackle from at least one lock from the set of locks is positioned through the first plurality of lock-receiving holes 12 and the second plurality of lock-receiving holes 13 as illustrated in FIG. 6.

Although the invention has been explained in relation to its preferred embodiment, it is to be understood that many other possible modifications and variations can be made without departing from the spirit and scope of the invention as hereinafter claimed.

What is claimed is:

1. A security device for retaining a key comprises:
a first rotational member;
a second rotational member;
a pivoting mechanism;
a first plurality of lock-receiving holes;
a second plurality of lock-receiving holes;
the first rotational member and the second rotational member each comprise a structural body;
the first plurality of lock-receiving holes traversing through the structural body of the first rotational member;
the second plurality of lock-receiving holes traversing through the structural body of the second rotational member;
the first rotational member being pivotally connected to the second rotational member through the pivoting mechanism;
the first plurality of lock-receiving holes being concentrically aligned with the second plurality of lock-receiving holes, wherein the first rotational member and the second rotational member are in a locked configuration; and
the first plurality of lock-receiving holes being offset from the second plurality of lock-receiving holes, wherein the first rotational member and the second rotational member are in an unlocked configuration.

2. The security device for retaining a key as claimed in claim 1 further comprises:
a key-receiving slot;
the first rotational member and the second rotational member each comprise a top surface and a bottom surface;
the structural body extending from the top surface to the bottom surface;
the key-receiving slot traversing into the structural body at the top surface of the second rotational member; and
the key receiving slot being positioned adjacent the second plurality of lock-receiving holes.

3. The security device for retaining a key as claimed in claim 2 further comprises:
a viewing aperture;
the viewing aperture traversing through the structural body of the first rotational member;
the viewing aperture being positioned adjacent the first plurality of lock-receiving holes; and
the viewing aperture being aligned with the key-receiving slot in the locked configuration.

4. The security device for retaining a key as claimed in claim 1 further comprises:
wherein the first rotational member and the second rotational member are in the locked configuration; and
the first rotational member being positioned in parallel to the second rotational member.

5. The security device for retaining a key as claimed in claim 1 further comprises:
wherein the first rotational member and the second rotational member are in the unlocked configuration; and
the first rotational member being oriented at an angle to the second rotational member.

6. The security device for retaining a key as claimed in claim 1 further comprises:
the pivoting mechanism comprises a rivet, a first rivet-receiving hole, and a second rivet-receiving hole;
the first rivet-receiving hole traversing through the structural body of the first rotational member;
the second rivet-receiving hole traversing through the structural body of the second rotational member;
the first rivet-receiving hole being concentrically aligned with the second rivet-receiving hole; and
the rivet being positioned into the first rivet-receiving hole and the second rivet-receiving hole.

7. The security device for retaining a key as claimed in claim 1 further comprises:
a first arced portion; and
the first arced portion being terminally connected to the structural body of the first rotational member.

8. The security device for retaining a key as claimed in claim 7 further comprises:
the first arced portion being positioned adjacent a first rivet-receiving hole of the pivoting mechanism; and
the first arced portion being positioned opposite a bottom edge of the first rotational member.

9. The security device for retaining a key as claimed in claim 1 further comprises:
a second arced portion; and
the second arced portion being terminally connected to the structural body of the second rotational member.

10. The security device for retaining a key as claimed in claim 9 further comprises:
the second arced portion being positioned adjacent a second rivet-receiving hole of the pivoting mechanism; and
the second arced portion being positioned opposite a bottom edge of the second rotational member.

11. A security device for retaining a key comprises:
a first rotational member;
a second rotational member;
a pivoting mechanism;
a first plurality of lock-receiving holes;
a second plurality of lock-receiving holes;
the first rotational member and the second rotational member each comprise a structural body;
the first plurality of lock-receiving holes traversing through the structural body of the first rotational member;
the second plurality of lock-receiving holes traversing through the structural body of the second rotational member;
the first rotational member being pivotally connected to the second rotational member through the pivoting mechanism;
the first plurality of lock-receiving holes being concentrically aligned with the second plurality of lock-receiving holes, wherein the first rotational member and the second rotational member are in a locked configuration; and
the first plurality of lock-receiving holes being offset from the second plurality of lock-receiving holes, wherein the first rotational member and the second rotational member are in an unlocked configuration.

12. The security device for retaining a key as claimed in claim 11 further comprises:
a key-receiving slot;
a viewing aperture;
the first rotational member and the second rotational member each comprise a top surface and a bottom surface;
the structural body extending from the top surface to the bottom surface;
the key-receiving slot traversing into the structural body at the top surface of the second rotational member;
the key receiving slot being positioned adjacent the second plurality of lock-receiving holes;
the viewing aperture traversing through the structural body of the first rotational member;
the viewing aperture being positioned adjacent the first plurality of lock-receiving holes; and
the viewing aperture being aligned with the key-receiving slot in the locked configuration.

13. The security device for retaining a key as claimed in claim 11 further comprises:
wherein the first rotational member and the second rotational member are in the locked configuration; and
the first rotational member being positioned in parallel to the second rotational member.

14. The security device for retaining a key as claimed in claim 11 further comprises:
wherein the first rotational member and the second rotational member are in the unlocked configuration; and
the first rotational member being oriented at an angle to the second rotational member.

15. The security device for retaining a key as claimed in claim 11 further comprises:
the pivoting mechanism comprises a rivet, a first rivet-receiving hole, and a second rivet-receiving hole;
the first rivet-receiving hole traversing through the structural body of the first rotational member;
the second rivet-receiving hole traversing through the structural body of the second rotational member;
the first rivet-receiving hole being concentrically aligned with the second rivet-receiving hole; and
the rivet being positioned into the first rivet-receiving hole and the second rivet-receiving hole.

16. The security device for retaining a key as claimed in claim 11 further comprises:
a first arced portion;
the first arced portion being terminally connected to the structural body of the first rotational member;
the first arced portion being positioned adjacent a first rivet-receiving hole of the pivoting mechanism; and
the first arced portion being positioned opposite a bottom edge of the first rotational member.

17. The security device for retaining a key as claimed in claim 11 further comprises:
a second arced portion;
the second arced portion being terminally connected to the structural body of the second rotational member;
the second arced portion being positioned adjacent a second rivet-receiving hole of the pivoting mechanism; and
the second arced portion being positioned opposite a bottom edge of the second rotational member.
